(19) United States
(12) Patent Application Publication
(10) Pub. No.: US 2011/0283777 A1
(43) Pub. Date: Nov. 24, 2011

(54) PORTABLE AUTOMOTIVE LEAK DETECTOR

(76) Inventor: Jeffrey T. Chrissis, Powell, OH (US)

(21) Appl. No.: 12/781,909

(22) Filed: May 18, 2010

(51) Int. Cl. G01M 3/20

(52) U.S. Cl. 73/40.7

(57) ABSTRACT

An automotive leak detector having a container of pressurized gas with an ultraviolet dye dispersed therein, flexible tubing, a regulator, and a pressure gauge. The container has an outlet to which the first end of the tubing is connected. The tubing also has a second end, with the second end having an outlet port. The regulator regulates the pressure of the gas and is attached to the tubing intermediate the first end of the tubing and the second end of the tubing. The pressure gauge is attached to the tubing intermediate the regulator and the second end of the tubing. The outlet port is dimensioned to facilitate attachment to the vapor recovery system access port of an automotive vehicle. Preferably the gas is a vapor made visible by shining an ultraviolet light thereon. Preferably the pressure gauge has a range of 0.1-20 pounds per square inch. Preferably the regulator maintains the pressure at the outlet of the tubing at approximately 1.5 pounds per square inch. A method of using the automotive leak detector to detect leaks in closed systems is also disclosed.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

This invention relates to an automotive vehicle vapor recovery system leak detector, and more particularly to one which is easily portable.

This invention is directed to a vapor recovery system leak detector. Since the mid to late 1990s, cars have featured an evaporative closed system featuring a sealed vapor recovery system. When there is a leak in a motor vehicle's sealed vapor recovery system, the motor vehicle's “check engine” light comes on to notify the driver to have the car serviced so that the site of the specific problem can be detected and then fixed.

Until now, the only way to test for and ascertain the location of leaks in these systems has been to utilize a machine which pumps smoke or a vapor through the system, with the smoke or vapor entering the vapor recovery system by means of an access port in the vapor recovery system.

One example of a prior art machine is disclosed in Pieroni et al, U.S. Pat. No. 6,439,031, which discloses a machine which produces smoke in a chamber by heating a mixture of oil and dye. The oil and dye is vaporized within the sealed chamber by coming into contact with a resistive heating grid connected to a battery. The oil and dye mixture is propelled into contact with the heating grid which is located above the oil supply by means of an air supply line connected to an air compressor or pump.

Another example of the prior art is Finlay et al, U.S. Pat. No. 6,907,771, which discloses a leak detecting apparatus that is connected to an external air supply that provides air under pressure. The air passes through a fluid tank where the air is directed against the fluid thereby generating fog which is then routed out of the apparatus and fed into the closed system to be tested. A light reflective pigment is added to the fluid to make the leak site easier to detect. The device also incorporates switches, gauges, lamps, and an electrical line for connection to an externally located battery.

Many existing testing machines can cost as little as $1,300, but typically cost at least $3,000. Unfortunately, most individual automotive enthusiasts, as well as many automotive shops, cannot afford to or do not want to spend that much money on existing testing machines. Consequently, the vehicle has to be taken to an automotive service facility that has such a device, where there will be a financial charge incurred in connection with the conducting of the test, or else due to cost and/or inconvenience involved the test will not be conducted.

From the foregoing discussion, it can be appreciated that financial considerations and the convenience associated with the ability to work on one's own car are very important to automotive enthusiasts. It is thus apparent that the need exists for an automotive vapor recovery system leak detector which is relatively easy and cost effective to fabricate and utilize in conjunction with automotive vehicles. Furthermore, given the fact that many automotive enthusiasts work in their garages where there often are space issues, having a leak detector that is portable would permit easier use of the device. Portability also permits the device to easily be transported to another site to work on another's vehicle.

### BRIEF SUMMARY OF THE INVENTION

In accordance with the present invention, there is disclosed an automotive leak detector having a container of pressurized gas with an ultraviolet dye dispersed therein, flexible tubing, a regulator, and a pressure gauge. The container has an outlet to which the first end of the tubing is connected. The tubing also has a second end, with the second end having an outlet port.

The regulator regulates the pressure of the gas and is attached to the tubing intermediate the first end of the tubing and the second end of the tubing. The pressure gauge is attached to the tubing intermediate the regulator and the second end of the tubing. The outlet port preferably is dimensioned to facilitate attachment to the vapor recovery system access port of an automotive vehicle.

Preferably the gas is a vapor which is made visible by shining an ultraviolet light thereon. Preferably the pressure gauge has a range of 0.1-20 pounds per square inch. Preferably the regulator maintains the pressure at the outlet of the tubing at approximately 1.5 pounds per square inch.

There is also disclosed an automotive leak detector having a container of pressurized gas, with the gas having an ultraviolet dye dispersed therein. The container also has an outlet for the gas to exit the canister. The detector also includes tubing having a first end connected to the outlet of the container, and with the tubing having a second end having an outlet port.

There is a regulator attached to the tubing intermediate the first end and the second end for regulating the pressure of the gas, with the pressure being approximately 1.5 pounds per square inch. The pressure gauge is attached to the tubing intermediate the regulator and the second end of the tubing with the pressure gauge having a range of 0.1-20 pounds per square inch.

The gas preferably is a vapor made visible by shining an ultraviolet light thereon. The outlet port is dimensioned to facilitate attachment to the vapor recovery system access port of an automotive vehicle.

The primary objective of this invention is to provide a portable automotive vapor recovery system leak detector.

Another objective of this invention is to provide an automotive vapor recovery system leak detector that is fairly simple to fabricate and consequently relatively inexpensive to produce.

Another objective of this invention is to provide such a device which is relatively inexpensive to purchase and easy to use.

Other objects and advantages of the invention will be apparent from the following description, the accompanying drawings and the appended claims.

### BRIEF DESCRIPTION OF THE SEVERAL VIEWS OF THE DRAWINGS

FIG. 1 is a schematic view of one embodiment of the new invention.

FIG. 2 is a schematic view of the invention in use.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other circuit elements where such connection is recognized as being equivalent by those skilled in the art. In addition, many circuits are illustrated which are of a type which perform well known operations on electronic signals. Those skilled in the art will recognize that there are many, and in the future may be additional, alternative circuits which are recognized as equivalent because they provide the same operations on the signals.

### DETAILED DESCRIPTION OF THE INVENTION

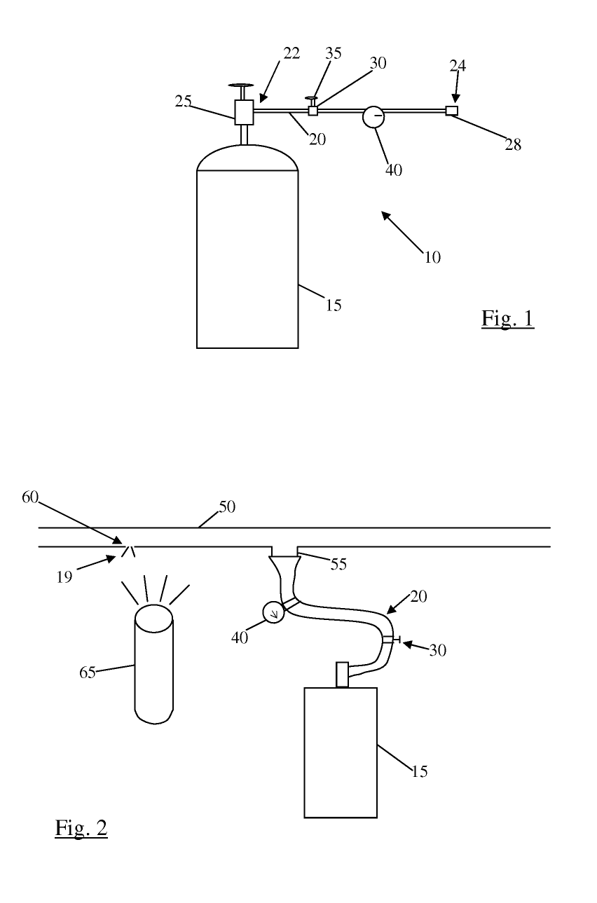

Having reference to the drawings, attention is directed first to FIG. 1, which discloses a schematic of an automotive leak detector made in accordance with the invention being designated generally by the numeral 10. As can be appreciated from FIG. 1, the automotive leak detector 10 has a canister 15 in the form of a sealed pressurized container containing a gas 18 having a dye 19 dispersed therein. The gas 18 may be in the form of air, a single or mixture of gases, a vapor, or artificial “smoke”. The dye 19 preferably is an ultraviolet one, so that in actual use its presence at the site of a leak can be readily detected.

Attached to the canister 15 is flexible tubing 20 having a first end 22 and a second end 24. The tubing may be rubber or one which is elastomeric. The first end 22 is attached to the canister 15 at a canister outlet 25 of the type known in the art of pressurized canisters. The distal end of the tubing 20 has a tubing outlet 28. The tubing outlet 28 is of a configuration that can be adapted to connect to the vapor recovery system access port of an automotive vehicle.

Intermediate the first end 22 and second end 24 of the tubing 20 is a regulator 30. The regulator 30 is attached to the tubing 20 and has control means 35 to control the pressure of the gas when it flows through the tubing outlet 28. The regulator is of the type well known in the art of controlling or regulating gas pressure. The control means 35 can be a valve, a knob, a switch, or another device that controls gas flow.

Attached to the tubing 20 intermediate the regulator 30 and tubing outlet 28 is a gauge 40 of the type well known in the art of pressure gauges. The gauge may be digital or with a pointer as shown in the drawings. The gauge permits the user of the invention to maintain the gas flow at about 1.5 pounds per square inch. Preferably the gas pressure ranges from 0.1-20 pounds per square inch.

In actual use, as disclosed in FIG. 2, the automotive leak detector of this invention is utilized by securing the outlet port of the tubing to the vapor system 50 to be tested at its access port 55. The regulator is adjusted so that the contents of the canister enter the closed system 50 preferably with a pressure of 1.5 pounds per square inch, with the pressure being verified by the gauge. After the gas enters the closed system to be tested, it will escape at the site 60 of any leak, where it can be ascertained by shining an ultraviolet light 65 in the vicinity of the system being tested. The site 60 of the escaping gas will be visibly noticeable due to the dye.

The automotive vehicle leak detector made in accordance with this invention is easy to fabricate and use. Additionally, due to its relatively compact size, it is portable and easily transportable. The cost and simplicity of use results in a leak detector that will please automotive enthusiasts. Although this device was designed for use with the vapor recovery systems of automotive vehicles, it could also be used in connection with the engine vacuum system and air conditioning system of vehicles.

While the form of apparatus herein described constitutes a preferred embodiment of the present invention, it is to be understood that the invention is not limited to this precise form of apparatus and that changes may be made therein without departing from the scope of the invention which is defined in the appended claims.

1. An automotive vehicle leak detector comprising
a container of pressurized gas, said gas having an ultraviolet dye dispersed therein, said container having an outlet,
tubing, said tubing having a first end connected to said outlet of said container, said tubing having a second end, said second end having an outlet port,
a regulator, said regulator attached to said tubing intermediate said first end and said second end for regulating the pressure of said gas, and
a pressure gauge attached to said tubing intermediate said regulator and said second end.

2. The automotive vehicle leak detector according to claim 1 wherein said outlet port is dimensioned to facilitate attachment to the vapor recovery system access port of an automotive vehicle.

3. The automotive vehicle leak detector according to claim 1 wherein said gas is a vapor made visible by shining an ultraviolet light thereon.

4. The automotive vehicle leak detector according to claim 1 wherein said pressure gauge has a range of 0.1-20 pounds per square inch.

5. The automotive vehicle leak detector according to claim 1 wherein said regulator maintains the pressure at the outlet at approximately 1.5 pounds per square inch.

6. An automotive leak detector comprising
a container of pressurized gas, said gas having an ultraviolet dye dispersed therein, said container having an outlet,
tubing, said tubing having a first end connected to said outlet of said container, said tubing having a second end, said second end having an outlet port,
a regulator, said regulator attached to said tubing intermediate said first end and said second end for regulating the pressure of said gas, said pressure being approximately 1.5 pounds per square inch, and
a pressure gauge attached to said tubing intermediate said regulator and said second end, said pressure gauge having a range of 0.1-20 pounds per square inch.

7. The automotive leak detector according to claim 6 wherein said gas is a vapor made visible by shining an ultraviolet light thereon.

8. The automotive leak detector according to claim 6 wherein said outlet port is dimensioned to facilitate attachment to the vapor recovery system access port of an automotive vehicle.
